(19) United States
(12) Patent Application Publication
(10) Pub. No.: US 2006/0196819 A1
(43) Pub. Date: Sep. 7, 2006

(54) External pressure hollow fibre membrane separation system

(76) Inventor: Xiao Long Lu, Tianjin (CN)

Correspondence Address: Leong C Lei, 1867 Ygnacio Valley Road, PMB#1008, Walnut Creek, CA, 94598, US

(21) Appl. No.: 10/551,808

(22) PCT Filed: Apr. 23, 2004
(86) PCT No.: PCT/CN04/00393

§ 371 Date: Sep. 30, 2005

(30) Foreign Application Priority Data
Apr. 23, 2003 (CN) 03122176.9

(51) Int. Cl. B01D 63/00

(52) U.S. Cl. 210/321.6

(57) ABSTRACT

A separating system of the hollow fiber membrane includes a membrane assembly, a cycling tank and pipelines, wherein the pipeline (40) for inlet of liquid is connected between the cycling trough (28) and the membrane assembly (21) to supply raw water to the membrane assembly; the pipeline (40) for inlet of liquid is equipped with pump (29), the raw water flow rate controller and the check valve for adding chemical reagent etc; the raw water flow rate controller is used to control a small amount of raw water to flow into the membrane assembly during the first cleaning status of cleaning the membrane assembly; The check valve for adding the chemical reagent is used to add the chemical reagent into the raw water during the first cleaning status of cleaning the membrane assembly.

### BACKGROUND OF THE INVENTION

1. Field of The Invention

The present invention relates to the membrane separation technology, especially an external compression separating system of hollow fiber membranes.

2. Description of Related Art

With the improving of the living standards, the water with higher quality is required, and so called pure water, space water or purified water is going into the daily life. Further, the water for production and industry such as biochemistry, medication, food, seasoning etc is required higher and higher on purity. In recent years, micro filtration and ultra filtration membranes for water purification were developed to accommodate such situations and have shown better practical effect. Among others, the external compression hollow fiber membrane is popular. The reason is that the external compression hollow fiber membrane (hereinafter called the membrane) has the advantage of the largest specific area of filled membrane in a unit volume, and can remove suspended matter such as the algae, microbe, and colloidal in raw water and has the higher purification level. However, in practical applications, the suspended matter may attach and accumulate in the cavity, pores and on the external wall of membrane, so the penetrability for water is degraded rapidly and even more blockage thereby to cause failed operation. Therefore, cleaning of the membrane is an important part of the applied technology.

The applicant has applied for many patents on cleaning technology of membrane. One of them is titled “A Separating System for External Compression Hollow Fiber Membrane & Operating Method Thereof” (CN1333080A). The document describes the key innovation on construction of the membrane and the connection of the water flow line, and offers a solution for effectively on-line cleaning. But there are some shortcomings in the system: it is imperfect in design of external pipelines for the membrane assembly. Another document titled “A Separating Apparatus for Hollow Fiber membrane & Operating Method Thereof” (CN1347752A) designed the chemical cleaning pipelines and the backwashing lines to complete the design of external pipelines of membrane assembly.

CN1347752A discloses a cleaning method, which includes the steps of: the first cleaning status, the compression air together with water clean the membrane assembly simultaneously, wherein the gas is used to conventional cleaning and the water is used to backwash. The chemical reagent such as oxidant may be added according to the requirement; the second cleaning status, a mount of backwashing liquid is used to clean the membrane, in other words, backwashing status.

The cleaning operation has some shortcomings: since the chemical reagent is added during the backwashing operation status, the chemical reagent itself is not cleaned thereby to pollute the liquid on the filtered liquid side of membrane. Thus, the quality of the water is not good, and it is difficult to purify the chemical reagent.

### SUMMARY OF INVENTION

The object of the present invention is to provide a cleaning system of the hollow fiber membrane separating apparatus which does not pollute the purified liquid.

The present invention is to provide a separating system of the hollow fiber membrane includes a membrane assembly, a cycling tank and pipelines, wherein the pipeline (40) for inlet of liquid is connected between the cycling trough (28) and the membrane assembly (21) to supply raw water to the membrane assembly; the pipeline (40) for inlet of liquid is equipped with pump (29), the raw water flow rate controller and the check valve for adding chemical reagent etc; the raw water flow rate controller is used to control a small amount of raw water to flow into the membrane assembly during the first cleaning status of cleaning the membrane assembly; The check valve for adding the chemical reagent is used to add the chemical reagent into the raw water during the first cleaning status of cleaning the membrane assembly.

### BRIEF DESCRIPTION OF THE DRAWINGS

FIG. 1 is a schematic overall diagram of an embodiment of the present invention;

FIG. 2 is another schematic overall diagram of an embodiment of the present invention.

### DETAILED DESCRIPTION OF THE PREFERRED EMBODIMENT

Detailed description of the present invention is given below by referring to the drawing and specific embodiments. The present system includes valves which are in operatively to perform the running, cleaning and draining of membrane assembly. The valves in drawings, according to the type, are divided into manual valves, pneumatic membrane valves (automatic valves).

According to the function or operation method, valves 1 and 1a are the pressure regulating valves for inlet, valves 11 and 11a are the automatic valves for inlet, valve 2 is a pressure regulating valve for outlet, valve 19 is an automatic valves for outlet, valves 4 and 5 are the switchover valve for switching between the state of running of the membrane and the sate of chemical cleaning of the membrane, valve 6 is a valve for inlet of pump, and valves 8 and 9 are the low level drainage valves. Valve 3 is a backwash regulating valve for regulating the flow rate of the backwash liquid, valve 15 is an automatic valve for backwashing, valve 7 is a valve for inlet of backwash pump, valve 12 is a cleaning air releasing valve, valve 13 is a cleaning drainage valve, valve 14 is a valve for outlet of filtered liquid, and valve 17 is an air inlet valve; valve 18 is an check valve for adding chemical reagent.

The P1, P2 and P3 in the drawings are the pressure meters and F1 is a flow rate meter or a flow rate sensor.

The location and function of valve will be described in detail according to the layout of pipelines in the following description.

In the present membrane assembly separating system, the membrane assembly is connected to multiple pipelines. The pipelines which are connected directly to membrane assembly include: the pipeline 40 for inlet of liquid, the pipeline 41 for outlet of liquid, cycling feedback pipeline 22, drainage pipelines 45, 46 and the pipeline 47 for supplying air etc. The pipeline 41 for outlet of liquid is connected to the chemical cleaning feedback pipeline 30, the pipeline 42 for supplying liquid and the pipeline 43 for backwashing. The relationship between the pipelines and the membrane assembly will be discussed below.

The pipeline 40 for inlet of liquid is connected between the cycling trough 28 and the lower port of membrane assembly 21 for supplying liquid to membrane assembly. The pipeline 40 for inlet of liquid is equipped with the manual valve 6 for inlet of the pump, the pump 29, the raw water flow rate controller and the check valve 18 for adding chemical reagent, etc.

One end of the pipeline 41 for outlet of liquid is connected to the upper port 23 of the membrane assembly 21 for discharging liquid from the tail end of the membrane assembly. The other end of the pipeline 41 is connected to two branches. One of them is the pipeline 42 for supplying liquid, which-is connected to the water producing trough 25 for directing the filtered liquid which is filtered by the membrane assembly in the operation status to the water producing trough 25. Another branch is the chemical cleaning feedback pipeline 30, which is connected to the cycling trough 28 for cycling the cleaning liquid containing chemical reagent during chemical cleaning after the membrane assembly have running for a relatively long period of time. The chemical cleaning feedback pipeline 30 is equipped with the switchover valve for switching. The pipeline 42 for supplying liquid is equipped with the valve 4 which is switched over by manual. During the normal running and cleaning of the membrane assembly, the valve 5 is closed and the valve 4 is opened. During chemical cleaning of the membrane assembly after running for 1 to 5 weeks, the valve 5 is opened and the valve 4 is closed.

The cycling feedback pipeline 22 is connected between the upper side port 16 of the membrane assembly 21 and the cycling trough 28, and is equipped with an automatic valve 19, a manual valve 2 and a pressure meter. The manual valve 2 and the pressure meter are used to regulate the pressure of system during the initial running of system. Only the automatic valve is in operation status during the automatic control period.

On the upper side port of the membrane assembly, there is the first drainage pipeline 45 to communicate with cycling feedback pipeline 22. The valve 12 on pipeline is used to control the operation of the first drainage pipeline.

There is the second drainage pipeline 46 on the low port 20 of the membrane assembly 21. The valve 13 on the pipeline is used to control the operation of the second drainage pipeline.

The low port 20 of the membrane assembly 21 is connected to the air-supplying pipeline 47 for supplying the compressed air. The compressed air from the air tank (not shown in figs), under the control of the gas flow rate meter and valves, is supplied to the membrane assembly in the first cleaning status (in other words, gas-water dual wash status).

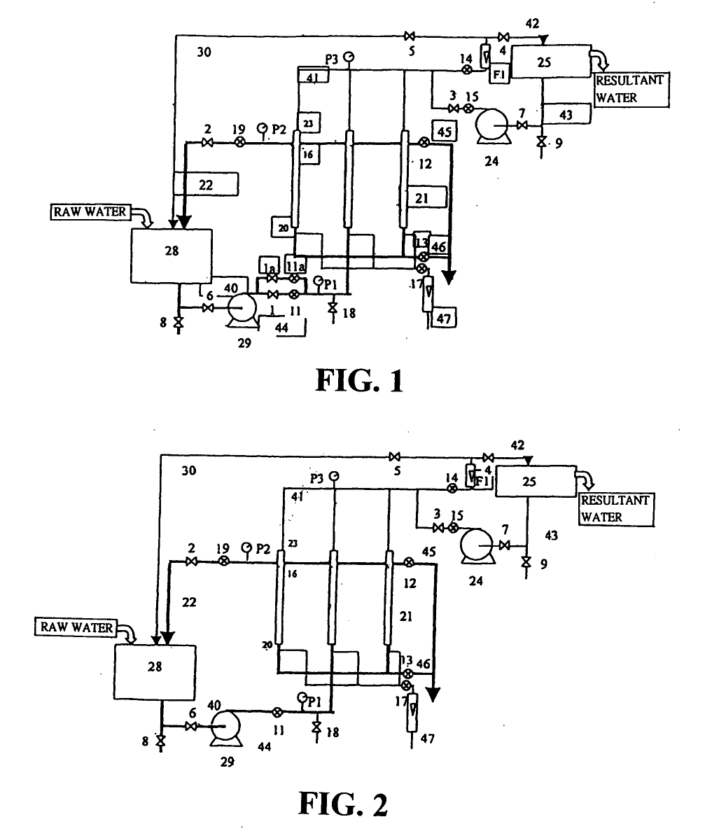

In the present separating system, as shown in the FIG. 1, the backwash pipeline 43 is connected on the tail end of the pipeline 41 for outlet of liquid before pipeline 41 connected to the two branch. The one end of the backwash pipeline 43 is connected to the pipeline 41 for outlet of liquid and the other end is connected to the resultant water tank 25. Further, there is the backwash pump 24; the backwash regulating valves 13, 15 on the pipeline. The backwash pipeline is used to supply backwash solution to membrane assembly 21 on the second cleaning status.

Another feature of the present invention is that the valve 18 for adding the chemical reagent is positioned on the pipeline 40 for inlet of liquid in order to adding the chemical reagent into the raw water in the first cleaning status. This is different from the prior art in which the valve for adding chemical reagent was amounted on the backwash pipeline or the pipeline for outlet of liquid. In the prior art, the chemical reagent is added into the backwash solution through the valve 18 for adding chemical reagent in the first cleaning status. The present invention has the advantage of not polluting the filtered liquid side of membrane assembly and not disturbing the quality of the resultant water.

The pipeline 40 for inlet of liquid may be equipped with two ports for adding chemical reagent, and two valves for adding chemical reagent respectively are needed. According to the quality of the water, the oxidant and /or the scale-resisting reagent can be added simultaneously and/or separately. The oxidant may be the sodium hypochlorite, ozone, chlorine dioxide etc. The scale-resisting reagent maybe the scale-resisting reagent product and hydrochloric acid, etc.

In the present invention, one of the embodiment of the raw water flow rate controller which is provided on the pipeline 40 for inlet of liquid is the double pipelines for inlet of liquid. As shown in the FIG. 1, the double pipelines 44 for inlet of liquid include the first pipeline for inlet of liquid which is equipped with the valves 1 and 11 and the second pipeline for inlet of liquid which is equipped with the valves 1a and 11a. The double pipelines 44 for inlet of liquid operate as below: the two pipelines is opened during the operating of the system; but in the first status, the automatic valve 11 is closed to cut the first pipeline for inlet of liquid thereby to decrease the flow rate to the 5%-50% of the rated flow rate.

Furthermore, in order to input a few of raw water into membrane assembly during the first cleaning status, the double pipelines for inlet of liquid may be substituted with frequency controller. Thus, only one valve for inlet is needed to control the raw water flow rate supplied by pump 29 via the frequency controller according to the FIG. 2.

The operation of the membrane separating system will be discussed in detail.

The present membrane separating system as shown by FIGS. 1 and 2 will operate as below.

1) Operating status.

The raw water in the cycling trough 28 is directed through the pipeline 40 for inlet of liquid then into the membrane assembly 21 under the control of the pump 29. After filtered by the membrane assembly, the filtered liquid exports from the upper port 23 of the membrane assembly. into water producing trough 25 via the pipeline 41 for outlet of liquid and the pipeline 42 for supplying liquid.

2) The first cleaning status.

By the control of the double pipelines 44 for inlet of liquid (as illustrated in FIG. 1) or the frequency controller (as illustrated in FIG. 2), the raw water flow rate for the outlet of the cycling trough 28 is decreased to the 5%-50% of the rated flow rate. The chemical reagent is added into a few of raw water passing the valve of adding chemical reagent. The oxidant and/or the scale-resisting reagent are added in accordance with the quality of the water. A few of the raw water are directed into membrane assembly to clean the membrane. At the same time, the compressed air flows into the membrane assembly 21 to perform the air washing via the air-supplying pipeline 47. Sullage is discharged from the first drainage pipeline 45. This status will last for 10-120 second.

3) The second cleaning status.

The backwashing resolution in the water producing trough 25 is directed through the backwash pipeline 43 and a portion of pipeline for outlet of liquid into the membrane assembly 21 to clean the membrane assembly 21 by the backwashing pump 24. Then the sullage is discharged by the first drainage pipeline 45 and the second drainage pipeline 46. The status will last for 10-120 second.

4) The drainage status.

After the second cleaning status, close the backwash feedback pipeline. Then the sullage in the pipelines and the membrane assembly is discharged completely by the first drainage pipeline 45 and the second drainage pipeline 46. The status will last for 0-120 seconds.

Depending on the actual requirement, the membrane assembly will be chemically cleaned after the membrane assembly run for 1-5 weeks.

### THE INDUSTRIAL EFFECT

The present invention has the following effects: the present cleaning apparatus and the operating method thereof for external compression hollow membrane assembly can be used to prevent the filtered side of the membrane from polluted by the chemical reagent thereby to increase the quality of the resultant water. Furthermore, since the organism on the face of membrane can be killed and removed by the oxidant and the scale-resisting reagent can remove inorganic substance on the face of the membrane, the membrane flux can be redeveloped by the virtue of the two reagents. Furthermore, the present invention can save the water for cleaning by directing less raw water d into the membrane assembly to clean the membrane.

What is claimed is:

1. A separating system of the hollow fiber membrane includes a membrane assembly, a cycling tank and pipelines, wherein the pipeline (40) for inlet of liquid is connected between the cycling trough (28) and the membrane assembly (21) to supply raw water to the membrane assembly; the pipeline (40) for inlet of liquid is equipped with pump (29), the raw water flow rate controller and the check valve for adding chemical reagent etc; the raw water flow rate controller is used to control a small amount of raw water to flow into the membrane assembly during the first cleaning status of cleaning the membrane assembly; The check valve for adding the chemical reagent is used to add the chemical reagent into the raw water during the first cleaning status of cleaning the membrane assembly.

2. The separating system of the hollow fiber membrane as set forth in claim 1, wherein the raw water flow rate controller is the double pipeline (44) for inlet of liquid, which include the first pipeline for inlet of liquid and the second pipeline for inlet of liquid; the double pipeline (44) for inlet of liquid is operated as below: the two pipelines is opened during the operating status of the system, but in the first status, close the first pipeline for inlet of liquid thereby to decrease the flow rate of entering to the 5%-50% of the rated flow rate.

3. The separating system of the hollow fiber membrane as set forth in claim 1, wherein the raw water flow rate controller is the frequency controller which is used to control the pump to decrease the flow rate of entering to the 5%-50% of the rated flow rate.

4. The separating system of the hollow fiber membrane as set forth in claim 1 or 2, wherein the backwash pipeline (43) is connected on the tail end of the pipeline for outlet of liquid before it is connected to the two branch, the backwash pipeline (43) is connected to the resultant water tank (25) to supply the backwash solution to the membrane assembly during the second cleaning status of cleaning the membrane assembly.

5. The separating system of the hollow fiber membrane as set forth in claim 1, wherein there are two valves for adding the chemical reagent which are used to add the oxidant and/or the scale-resisting reagent simultaneously and/or separately according to the quality of the water; the oxidant maybe the sodium hypochlorite, ozone, chlorine dioxide etc; and the scale-resisting reagent maybe the scale-resisting reagent product and hydrochloric acid etc.

6. The separating system of the hollow fiber membrane as set forth in claim 1, wherein the oxidant or the scale-resisting reagent is added according to the quality of the water; the oxidant may be the sodium hypochlorite, ozone, chlorine dioxide etc; and The scale-resisting reagent may be the scale-resisting reagent product and hydrochloric acid etc.
